(19) United States
(12) Patent Application Publication
(10) Pub. No.: US 2017/0015162 A1
(43) Pub. Date: Jan. 19, 2017

(54) Hitch Drawbar and Winch Accessory Mount

(71) Applicant: John Walter, Florissant, MO (US)

(72) Inventor: John Walter, Florissant, MO (US)

(21) Appl. No.: 15/208,130

(22) Filed: Jul. 12, 2016

Related U.S. Application Data
(60) Provisional application No. 62/192,640, filed on Jul. 15, 2015.

(51) Int. Cl. B60D 1/18; B60D 1/06

(52) U.S. Cl. CPC B60D 1/187; B60D 1/06; B60D 1/185

(57) ABSTRACT

A hitch drawbar is provided that supports a hitch ball and a winch accessory mount for supporting a winch or similar accessory above the draw bar. The draw bar includes a first end and a second end. The first end is adapted to be received and secured by a vehicle hitch receiver. The second end supports a hitch ball therefrom. Along the draw bar length, the winch accessory mount extends upwards. The winch accessory mount supports a winch surface above the draw bar and substantially parallel thereto. Along the surface, a winch may be supported. In addition, the winch surface may support alternative accessories thereon. Several embodiments are disclosed, including slidable configurations of the hitch ball surface and slidable configurations of the winch accessory mount and winch surface. Overall, the present invention provides a new and novel draw bar and hitch accessory mount.

### CROSS REFERENCE TO RELATED APPLICATION

This application claims the benefit of U.S. Provisional Application No. 62/192,640 filed on Jul. 15, 2015. The above identified patent application is herein incorporated by reference in its entirety to provide continuity of disclosure.

### BACKGROUND OF THE INVENTION

Field of the Invention

The present invention relates to trailer hitches and accessories therefor. More specifically, the present invention relates to a new trailer hitch draw bar that includes a winch support extending therefrom.

A winch is a useful tool for towing and for moving heavier loads. Often, winches are affixed to the front or rear of a vehicle and used to move cargo or pull objects using the weight of the vehicle and the cable of the winch. However, when the rear of a vehicle includes a hitch that is engaged with a towed vehicle, the space and connection point for a rear-mounted winch is limited. This is inconvenient, particularly for winches that can be operably affixed to the trailer hitch receiver. When the hitch is in use, the user is prevented from utilizing the trailer hitch in conjunction with a winch at the same time. Thus, a device for mounting a winch to the rear of a vehicle without limiting access to the trailer hitch is desired.

The present invention provides such a device, whereby a trailer hitch includes an accessory mount for supporting a winch thereon. In particular, the assembly comprises a draw bar that supports a hitch ball and the accessory mount extending therefrom. From the accessory mount is a winch carrier rack, whereon a winch can be secured. Forces from the winch are transferred through the winch carrier rack, through the accessory bar, into the draw bar and into the vehicle hitch receiver. In this way, the user can utilize the hitch for supporting a towed vehicle, while simultaneously supporting a winch therefrom.

### SUMMARY OF THE INVENTION

The following summary is intended solely for the benefit of the reader and is not intended to be limiting in any way. The present invention provides a new trailer hitch draw bar assembly that can support a winch device.

It is therefore an object of the present invention to provide a new and improved trailer hitch draw bar assembly that has all of the advantages of the prior art and none of the disadvantages.

It is another object of the present invention to provide a trailer hitch draw bar assembly that can be used to support a towed vehicle or trailer, and furthermore that can support a winch therefrom.

Another object of the present invention is to provide a trailer hitch draw bar assembly that comprises a hitch draw bar, a draw bar accessory mount, and a hitch ball mount for supporting a hitch ball thereon.

Another object of the present invention is to provide a trailer hitch draw bar assembly, whereby the hitch draw bar comprises an elongated bar length, a first end, and a second end. The first end of the hitch draw bar is adapted to be received within a trailer hitch receiver, while the second end supports the hitch ball mount for supporting a hitch ball thereon.

Another object of the present invention is to provide a trailer hitch draw bar assembly in which the hitch ball mount is movable relative to the hitch draw bar. The hitch ball mount comprises a ball mount surface and an upstanding post member. The second end of the hitch draw bar includes a sleeve, whereby the upstanding post member of the hitch ball mount is slidable therein. This allows the position of the hitch ball mount to be slidably movable relative to the hitch draw bar.

Another object of the present invention is to provide a trailer hitch draw bar assembly, whereby the sleeve of the hitch draw bar supports the upstanding post member of the hitch ball mount such that the upstanding post member is substantially perpendicular to the hitch ball mount and the ball mount surface is substantially parallel to the hitch ball mount. To secure the post member to the hitch bar sleeve, the sleeve and the upstanding post member have one or more pairs of apertures that can be aligned and receive a pin therethrough to lock the relative position of the post within the sleeve.

Another object of the present invention is to provide a trailer hitch draw bar assembly, whereby the draw bar accessory mount extends substantially perpendicularly upwards from the draw bar along its length and between the first end and second end thereof. The draw bar accessory mount is adapted to support a winch or a winch carrier rack therefrom.

Another object of the present invention is to provide a trailer hitch draw bar assembly, whereby the draw bar accessory mount has a height with an upper end and a lower end, and whereby the winch carrier rack extends substantially parallel to the hitch draw bar length and above the hitch ball mount. The winch carrier rack is adapted to support a winch therefrom.

Another object of the present invention is to provide a trailer hitch draw bar assembly, whereby winch carrier rack connects to the draw bar accessory mount via an elongated winch support bar affixed to the draw bar accessory mount. The winch support bar is supported within a slot in the draw bar accessory mount that is adapted to slidably receive the winch support bar therethrough.

Another object of the present invention is to provide a trailer hitch draw bar assembly, whereby the winch support bar has a pair of aligned apertures adapted to receive a pin therethrough, and the draw bar accessory mount has a pair of aligned apertures adapted to receive a pin therethrough. The apertures of the winch support bar and the draw bar accessor mount are aligned and receive a pin therethrough when securing the winch support bar to the draw bar accessory mount.

Another object of the present invention is to provide a trailer hitch draw bar assembly, whereby the draw bar accessory mount further comprises a retainer ring extending therefrom and along its height.

Another object of the present invention is to provide a trailer hitch draw bar assembly, whereby the draw bar accessory mount further comprises a retainer slot extending therefrom and along its height.

Another object of the present invention is to provide a trailer hitch draw bar assembly, whereby in on embodiment, the draw bar accessory mount is slidably mounted to the draw bar along the length of the draw bar. The draw bar accessory mount further comprises a second slot adapted to receive the draw bar therethrough.

Another object of the present invention is to provide a trailer hitch draw bar assembly, whereby the draw bar accessory mount has a pair of aligned apertures adapted to receive a pin therethrough for securing the draw bar accessory to a pair of apertures in the draw bar along the length of the draw bar.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 provides a perspective view of one embodiment of the trailer hitch draw bar assembly of the present invention, whereby the winch is not connected to the winch accessory mount.

FIG. 2 provides another perspective view of an embodiment of the trailer hitch draw bar assembly, wherein the winch carrier rack is not shown.

FIG. 3 provides a perspective view of yet another embodiment of the trailer hitch draw bar assembly, whereby the winch carrier rack is supporting a winch therefrom.

### DETAILED DESCRIPTION OF THE INVENTION

Reference is made herein to the attached drawings. Like reference numerals are used throughout the drawings to depict like or similar elements of the trailer hitch draw bar assembly of the present invention. For the purposes of presenting a brief and clear description of the present invention, the preferred embodiment will be discussed as used for supporting a winch from the draw bar of a trailer hitch. The figures are intended for representative purposes only and should not be considered to be limiting in any respect.

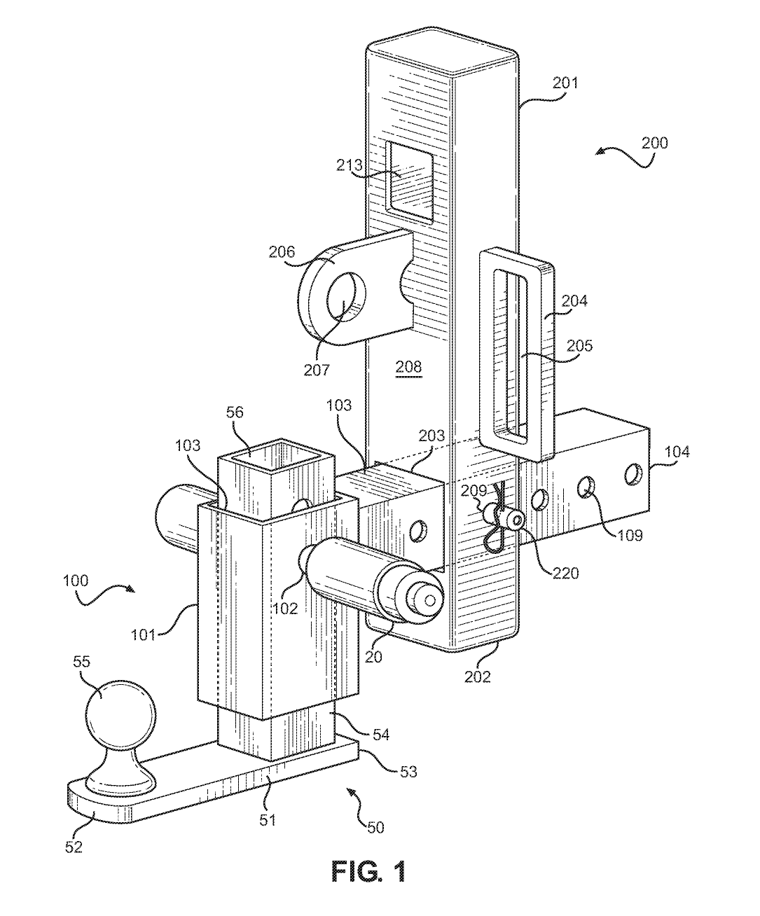

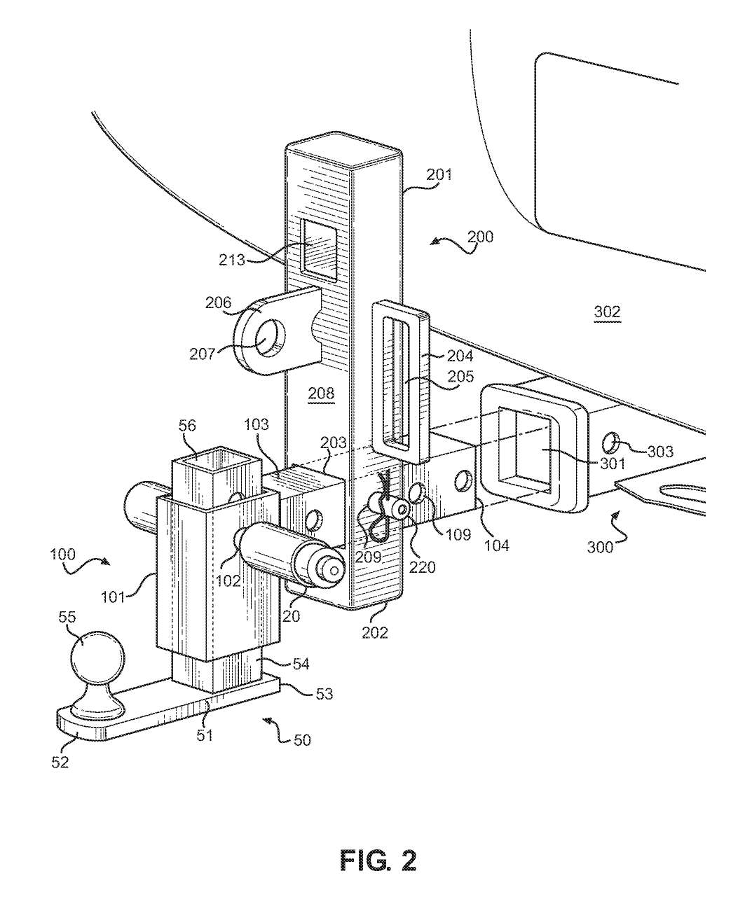

Referring now to FIGS. 1 and 2, there are shown views of an embodiment of the trailer hitch draw bar assembly of the present invention. The trailer hitch draw bar assembly is one that is adapted to be supported by the trailer hitch 300 of a lead vehicle, and one that provides towing ability and support for a winch thereon. In particular, the assembly comprises a hitch draw bar 103 having a length, a first end 104, and a second end 101. The draw bar 103 is sized to be received within the hitch receiver 301 of a trailer hitch 300, wherefrom the assembly is statically supported by the vehicle. The first end 104 of the draw bar 103 is inserted into the interior of the receiver 301, whereafter a locking pin 308 is used to secure the draw bar 103 therein. The locking pin 308 is inserted through aligned apertures 303, 109 in the draw bar 103 and the hitch receiver. Thereafter, the draw bar 103 is cantilevered from the hitch 300.

Along the second end 101 of the draw bar 103 is a hitch ball mount 50 for supporting a hitch ball 55 thereon. The hitch ball mount 50 comprises a hitch ball mount surface 51 that is substantially parallel to the length of the draw bar 103 and may be offset therefrom. In particular, the hitch ball mount surface 51 includes a first end 53 and a second end 52, whereby the hitch ball 55 is supported along the second end 52 of the surface 51. Along the first end 53 is an upstanding post member 54 that connects to the second end 101 of the draw bar 103. The post 54 and the draw bar 103 may be statically joined, formed of a single construction, or alternative (and as presented in FIGS. 1-2), slidably connected.

In one embodiment, the upstanding post member 54 includes an upper end 56 and a height, whereby the post member 54 is adapted to be received within a sleeve disposed along the second end 101 of the draw bar 103. The post member 54 is slidably received in the sleeve and securable thereto using a pin lock. A slide pin 20 is inserted into an aperture 102 in the sleeve, which is aligned with apertures in the upstanding post 54 member. The pin 20 is insertable through the post and through the sleeve to lock the post to the sleeve in a desired location. This allows the height of the hitch ball mount surface 51 to be adjusted relative to the draw bar 103. In other embodiments, the hitch ball mount surface 51 is statically affixed relative to the draw bar 103.

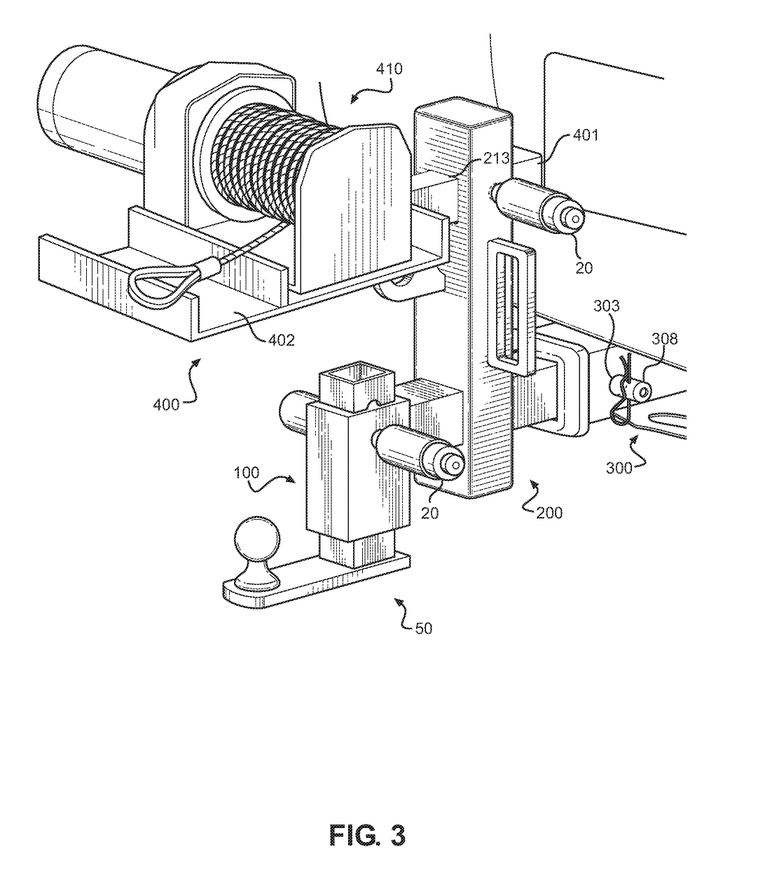

Along the length of the draw bar 103 is a draw bar accessory mount 200 that extends upwards and substantially perpendicularly from the draw bar 103. The draw bar accessory mount 200 is a mounted between the first end 104 and second end 101 of the draw bar 103, and is adapted to provide a structure to support a winch carrier rack therefrom (FIG. 3). In one embodiment, the draw bar accessory mount 200 is statically affixed to the draw bar 103. In other embodiments, the draw bar accessory mount 200 is slidable relative to the draw bar 103 to allow positioning along its length. In this latter embodiment, the draw bar accessory mount 200 includes apertures 209 that align with apertures 109 in the draw bar 103. A pin lock 220 secures through the aligned apertures 109, 209 to secure the draw bar accessory mount 200 in place along the length of the draw bar 103.

The draw bar accessory mount 200 has a height with an upper end 201 and a lower end 202. Referring to FIGS. 1-3, the draw bar accessory mount 200 is shown connected and separated from the winch carrier rack 400. The winch carrier rack 400 is a structure that extends substantially parallel to the hitch draw bar 103 and is disposed above the hitch ball mount 50. The winch carrier rack 400 is adapted to support a winch 410 therefrom, whereby the ball mount 50 of the draw bar can be used to connect to a trailer vehicle while the winch 410 is in operation.

The winch carrier rack 400 connects to the draw bar accessory mount 200 via an elongated winch support bar 401 that is either affixed to the draw bar accessory mount 200 or slidably positioned relative thereto. In one embodiment, the winch carrier rack 400 connects to the draw bar accessory mount 200 via an elongated winch support bar 401 that is supported within a slot 213 in the draw bar accessory mount 200 that is adapted to slidably receive the winch support bar 401 therethrough. To secure the two together, the draw bar accessory mount 200 further comprises one or more pairs of aligned apertures adapted to receive a pin 20 therethrough, whereby the pin secures through aligned apertures in the winch support bar 213. One or more sets of aligned apertures may be provided along the winch support bar 401 and the draw bar accessory mount 200 to set the desired location of the winch carrier rack 400 relative to the draw bar 103.

The draw bar accessory mount 200 may further comprise additional attachment points for chains, hooks, and other items. These may include a retainer ring 206 extending therefrom and along its height. The retainer ring 206 comprises a bracket with an aperture 207 adapted to receive a hook, clasp, or another hardware article that may be necessary when securing the winch cable during non-use or chains between the towed vehicle and the trailer hitch 300. In addition to the retainer ring 206, the draw bar accessory mount 200 may further include a retainer slot 204 extending the height of the draw bar accessory mount 200. The slot 204 includes an elongated channel 205 that may similarly be used to secure hardware, chains, and accessory items to the assembly.

The winch carrier rack 400 of the present invention may comprise any structure suitable for supporting the weight of a cable winch 410 thereon and operating loads during use. This may include a large clevis for supporting the winch 410 along its ends, a specific bracket for the same, or alternatively a surface 402 upon which a winch 410 may be fastened and supported.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A trailer hitch device, comprising:
a hitch draw bar comprising an elongated bar length, a first end, and a second end;
the first end being adapted to be received within a trailer hitch receiver;
the second end further comprising a hitch ball mount for supporting a hitch ball thereon;
a draw bar accessory mount extending substantially perpendicularly upwards from the draw bar along its length and between the first end and second end thereof;
the draw bar accessory mount having a height with an upper end and a lower end;
a winch carrier rack extending from the draw bar accessory mount along its height;
the winch carrier rack extending substantially parallel to the hitch draw bar and above the hitch ball mount;
the winch carrier rack being adapted to support a winch therefrom.

2) The trailer hitch device of claim 1, wherein:
the hitch ball mount being movable relative to the hitch draw bar;
whereby the hitch ball mount further comprises a ball mount surface and an upstanding post member;
the second end of the hitch draw bar further comprising a sleeve, whereby the upstanding post member of the hitch ball mount is slidable therein;
whereby the sleeve supports the upstanding post member of the hitch ball mount such that the upstanding post member is substantially perpendicular to the hitch ball mount and the ball mount surface is substantially parallel to the hitch ball mount;
the sleeve having a pair of aligned apertures;
the upstanding post member having one or more pairs of aligned apertures;
the upstanding post member being securable to the sleeve using a pin inserted through the aligned apertures of the sleeve and the upstanding post member.

3) The trailer hitch device of claim 1, wherein:
the winch carrier rack connects to the draw bar accessory mount via an elongated winch support bar affixed to the draw bar accessory mount.

4) The trailer hitch device of claim 1, wherein:
the winch carrier rack connects to the draw bar accessory mount via an elongated winch support bar that is slidably affixed to the draw bar accessory mount;
the winch support bar being supported within a slot in the draw bar accessory mount adapted to slidably receive the winch support bar therethrough.

5) The trailer hitch device of claim 4, wherein:
the winch support bar having a pair of aligned apertures adapted to receive a pin therethrough;
the draw bar accessory mount having a pair of aligned apertures adapted to receive a pin therethrough;
a pin for securing the winch support bar to the draw bar accessory mount.

6) The trailer hitch device of claim 1, wherein the draw bar accessory mount further comprising a retainer ring extending therefrom and along its height.

7) The trailer hitch device of claim 1, wherein the draw bar accessory mount further comprising a retainer slot extending therefrom and along its height.

8) The trailer hitch device of claim 1, wherein:
the draw bar accessory mount is slidably mounted to the draw bar along the length of the draw bar;
whereby the draw bar accessory mount further comprises a second slot adapted to receive the draw bar therethrough.

9) The trailer hitch device of claim 8, wherein:
the draw bar accessory mount has a pair of aligned apertures adapted to receive a pin therethrough for securing the draw bar accessory to a pair of apertures in the draw bar along the length of the draw bar.
